(19) United States
(12) Patent Application Publication
(10) Pub. No.: US 2025/0186901 A1
(43) Pub. Date: Jun. 12, 2025

(54) APPARATUS AND METHOD FOR TREATMENT OF AQUEOUS WASTE MATERIAL

(71) Applicant: PharmaLundensis AB, Lund (SE)

(72) Inventors: Staffan SKOGVALL, Lund (SE); Bo WENNERGREN, Södra Sandby (SE)

(73) Assignee: PharmaLundensis AB, Lund (SE)

(21) Appl. No.: 18/844,422

(22) PCT Filed: Dec. 14, 2022
(86) PCT No.: PCT/EP2022/085882

§ 371 Date: Sep. 6, 2024

(30) Foreign Application Priority Data
Mar. 8, 2022 (SE) 2250305-6

(51) Int. Cl. B01D 1/00

(52) U.S. Cl. CPC B01D 1/00; B01D 2257/80

(57) ABSTRACT

An apparatus and a method for handling aqueous waste material by boiling are disclosed. An outer vacuum (Vo) is applied in a container (100) outside a single-use waste bag (10) received in the container (100) to hold the waste bag (10) against an inner sidewall (104) of the container (100). An inner vacuum is applied inside the 5 waste bag to lower the boiling point of a waste material therein. The inner vacuum is lower than or equal to the outer vacuum. While applying the inner vacuum, water is vaporized from the waste material to produce a water-reduced waste residual. Vaporizing is accomplished by heating an inner sidewall (104) of the container and by heat transfer from the heated inner sidewall, through the waste bag, and to the 0 waste material in the waste bag. A full waste bag with the waste residual therein is eventually removed from the container.

### TECHNICAL FIELD

The present invention relates to the field of waste treatment, management, and handling. More specifically, the inventive concept is directed to the field of treatment of aqueous waste material by boiling or evaporation to produce a water-reduced waste material. Boiling or evaporation is a preferred method for handling hazardous waste material. The waste material may be contaminated water comprising dissolved substances.

### BACKGROUND

Evaporation or boiling is a known method for handling of hazardous waste material, wherein the waste material is heated in one or more evaporation tanks to accomplish a vaporization of water from the waste material by boiling. The resulting water-reduced waste material may subsequently be subject to a destruction, such as incineration.

Conventional evaporator apparatuses are normally large and expensive, often including a number of large steel tanks for reducing the water contents of the waste material in a sequence of vaporization steps. Such known apparatuses are not suitable for situations where only smaller or moderate volumes of waste material are to be handled. A further drawback with such conventional evaporator apparatuses is that the final water-reduced waste material is still in liquid form in order to be removed from the vaporization tank, which is a drawback with respect to subsequent handling of the treated waste material. If the evaporation is driven to far, the aqueous waste material may become gradually more saturated, and dissolved substances may precipitate and foul the vaporization tanks. Furthermore, it may be impossible or at least very difficult to remove a too solid or dry final waste material from the vaporization tank.

### SUMMARY OF INVENTION

In the light of the above, it is an object of the present inventive concept to provide an apparatus and a method wherein the above-mentioned disadvantages of the prior art are addressed.

According to a first aspect of the inventive concept, there is provided an apparatus for handling aqueous waste material, said apparatus comprising:
a waste bag;
a container arranged to receive the waste bag;
means for applying an outer vacuum in the container outside the waste bag to hold the waste bag against an inner sidewall of the container;
means for transferring an aqueous waste material into the waste bag in the container;
means for applying an inner vacuum inside the waste bag to lower the boiling point of the waste material, wherein the inner vacuum is lower than or equal to the outer vacuum;
and
heating means for heating the inner sidewall to accomplish a heat transfer through the waste bag into the waste material and, thereby, a vaporization of water from the waste material to produce a water-reduced waste residual in the waste bag.

According to a second aspect of the inventive concept, there is provided a method for handling aqueous waste material, said method comprising:
inserting a waste bag into a container;
applying an outer vacuum in the container outside the waste bag to hold the waste bag against an inner sidewall of the container;
transferring an aqueous waste material into the waste bag;
applying an inner vacuum inside the waste bag to lower a boiling point of the waste material, wherein the inner vacuum is lower than or equal to the outer vacuum;
while applying the inner vacuum, vaporizing water from the waste material in the waste bag to produce a water-reduced waste residual in the waste bag, wherein said vaporizing being accomplished by heating the inner sidewall of the container and by heat transfer from the heated inner sidewall, through the waste bag, and to the waste material in the waste bag; and
removing the waste bag with the waste residual therein from the container.

### Terminology

The term “vacuum” should be interpreted in a broad sense as a state where the pressure is below atmospheric pressure (sometimes referred to as “partial vacuum” or “imperfect vacuum” in the literature). Furthermore, vacuum level is expressed as inverse or opposite to pressure level: a higher vacuum corresponds to a lower pressure, and vice versa.

In the present disclosure, the term “evaporation” should be interpreted in a broad sense, especially it should be interpreted as including boiling. This meaning of the term “evaporation” is used in the technical field where the waste material is actually boiled, whereas a stricter physical definition of “evaporation” implies that the vaporization occurs on the surface of the liquid without bubble formation in the liquid volume (boiling). The term evaporation is also used in situations where a liquid changes to a gas at a temperature below its normal boiling point.

According to the inventive concept, the waste bag is held in close contact with an inner sidewall of the container by the outer vacuum. In its broadest sense, the term “inner sidewall” should be interpreted as a wall defining an inner bag-receiving chamber of the container. The inner sidewall may form an inner wall of a double-sided container, and in simpler embodiments the container may be a single-walled container where the waste bag is held against the inner side of a single wall. Furthermore, the expression “applying an outer vacuum in the container outside the waste bag to hold the waste bag against an inner sidewall of the container” is to be interpreted as also covering embodiments where some parts of the waste bag may not have contact with the inner sidewall of the container.

The inventive concept presents a plurality of advantages:

An advantage is that the inventive concept provides a cost and energy efficient way of handling aqueous waste material by vaporization in a single vaporization container, especially for handling moderate or minor volumes of aqueous waste material.

A special advantage relates to the degree of water reduction. Performing the boiling (evaporation) of the waste material inside a waste bag makes it possible to use single-use waste bags which may typically be subsequently destroyed together with the waste residual therein. Using single-use waste bags have the advantage that the vaporization can proceed to a degree where the waste residual is a completely or almost dry waste residual, i.e., an essential solid waste residual. Typically, the vaporization may proceed as far as practical possible. As an example, the water content of the waste residual may be below 1%. Since the waste residual is contained in the waste bag, there is no risk of fouling or damaging the container.

A further advantage is that the inventive concept makes it possible to use thin-walled waste bags in the process. In general, a thickness under 6 mm is preferred, but the inventive vacuum technology makes it possible to use waste bags having a thickness under 0.5 mm, and especially under 0.2 mm. Using thin-walled waste bags in the process is preferred for optimizing the heat transfer through the waste bag from the heated inner sidewall of the container to the waste material during the vaporization. Thin-walled waste bags also have the advantage of being more flexible. However, a potential drawback of thin-walled waste bags is that they may be more prone to rupture. According to the inventive concept, thin-walled waste bags may nevertheless be used since the outer vacuum, which is applied outside the waste bag between the waste bag and the container, will hold the waste bag against the inner sidewall of the container, thereby substantially reducing the risk of bag rupture during the vaporization process. In preferred embodiment, almost the entire waste bag is supported by the inner sidewall of the container, possibly except for a top part of the waste bag close to the fill opening of the waste bag. The vacuum being larger than or equal to the inner vacuum inside the waste bag prevents the waste bag from rupturing by collapsing inwards into the container under influence of the inner vacuum inside the waste bag. Furthermore, the outer vacuum ensures that the waste bag is held against and supported by the inner sidewall of the container during the vaporization process, providing the advantage that the weight of the waste material inside the waste bag will not cause a thin-walled waste bag to rupture.

A further advantage of the inventive concept is that the application of the outer vacuum makes it possible to perform the boiling (vaporization) in the waste bag at a lowered boiling point by applying an inner vacuum inside the waste bag, without any risk of the waste bag collapses inwards under influence of the inner vacuum.

A further advantage is that the inventive concept makes it possible to handle aqueous waste material by subjecting the waste material to a vaporization in one single container/waste bag only, i.e., without performing any pre-vaporization in a prior vaporization step. The inventive apparatus may be considered as a single-container type vaporization apparatus.

Non-limiting embodiments of the inventive concept are set out in the dependent claims. The features set out in the dependent claims are to be considered as optional features of the inventive concept in its broadest aspect.

The waste bag may typically be a relatively thin bag. The thickness may be less than 6 mm. In preferred embodiments, the bag thickness is less than 0.5 mm, and especially less than 0.2 mm. A small bag thickness has the advantage of providing a more efficient heat transfer through the waste bag. A small bag thickness has also the advantage of the waste bag being more flexible to adapt to the inner shape of the container.

The waste bag may be made from foil material. In preferred embodiments, the waste bag may be made at least partly from a metal foil, such as an alumina foil. A plastic foil may also be possible, and also a combination of metal foil material and plastic foil material. An advantage of using metal at least in part of the waste bag is to increase the strength of the waste bag. Metal may also be beneficial to increase the heat conductivity of the waste bag.

In preferred embodiments, the waste bag is “oversized” in relation to the inner chamber of the container in which it is received. Specifically, a maximum volume of the waste bag is preferably sufficiently large in relation to the inner dimensions of the bag-receiving inner chamber of the container that the waste bag is prevented from expanding, under the influence of the outer vacuum, to its maximum volume. Such a design of the waste bag in relation to the container prevents rupture of the waste bag due to excessive bag expansion.

In order to accomplish an efficient heat transfer to the waste material inside the waste bag, the waste bag may be shaped as an elongate tube with a limited cross section, and be oriented essentially vertically during use. The cross section of the tube may correspond largely to an inner cross section of the inside of the container. As a non-limiting example, the initial empty waste bag, before application of the outer vacuum, may have a height (tube length) in the order of 1 meter, and an essentially square cross section with a side length of about 15 cm. Limiting the cross-sectional area of the waste bag has the advantage of providing a more efficient heat transfer to the waste material therein. An elongate shape of a vertically standing waste bag is beneficial for performing a repeated filling of waste material into the waste bag. Upon application of the outer vacuum, the shape of the container may change to closely follow the shape of the inner sidewall of the container, for instance a cylindrical shape.

In some embodiments, the thickness and material of the waste bag may be selected such that the waste bag cannot by itself support the weight of the waste material therein. During the vaporization, the waste bag is supported by the inner sidewall and the inner bottom of the container. During removal of the waste bag with the waste residual therein from the container, the full waste bag may be handled by some other support means, such as a lifting table or the like.

For accomplishing the heating, the container may be structured as a double-walled container having an inner bag-receiving chamber defined by said inner sidewall, a container bottom, and a container top, and further having an outer sidewall. Heating means may be arranged to heat the inner sidewall by applying heat in a space between the outer sidewall and the inner sidewall of the container. For instance, a heating liquid such as heated water may circulate in said space. The heated liquid, such as heated water, may be provided from heating means being part of the apparatus or being externally connected heating means.

In some embodiments, the container may comprise an openable container lid for allowing the waste bag to be received in the container. The container lid may be openable by being completely removable from the container. A coupling unit may be arranged to be connected to an opening of the waste bag to establish a connection from the outside of the container to the inside of the waste bag, allowing transferring of waste material into the waste bag, allowing application of the inner vacuum inside the waste bag, and allowing removal of vaporized water from the waste bag. In some embodiments, the coupling unit additionally allows air to enter into the waste bag during an initial bag expansion of a newly inserted waste bag, and to escape from the waste bag during filling of waste material. The coupling unit may typically present outer connectors, accessible at the outside of the container, for releasable attachment to conduits for waste material, inner vacuum, water vapor, and air. The coupling unit may be fixed to the openable lid. In preferred embodiments to allow a more convenient bag replacement procedure, the coupling unit may be releasably and sealingly mounted in an opening in an openable top lid of the container. In such embodiments, a new empty waste bag may be installed by opening the top lid; releasing the coupling member from the top lid; disconnecting the coupling member from a previously filled waste bag; connecting the coupling member to a new empty waste bag; before or after connecting the coupling member to the new bag inserting the new bag into the container; sealingly reattaching the coupling member to the top lid; and closing the top lid. In some embodiments, such a coupling unit may be a single-use coupling unit.

In preferred embodiments the outer vacuum is applied at least initially after inserting a new waste bag into the container, before initiating the transfer of waste material into the new waste bag. The initial application of the outer vacuum draws the waste bag towards the inner sidewall of the container, such that the waste bag is held in close contact with the inner sidewall. In embodiments where a new waste bag is provided in a rolled or folded shape, the initial application of the outer vacuum may also have the effect of unfolding a new waste bag in a convenient manner. The outer vacuum maintains the waste bag in close contact with the inner sidewall of the container during boiling. The close contact preferably extends over the entire sidewall surface, i.e., around the perimeter of the waste bag. The bottom of the waste bag is preferably resting on an inner bottom surface of the container.

In preferred embodiments, the outer vacuum holding the waste bag in close contact with the inner sidewall of the container is maintained while applying the inner vacuum inside the waste bag during vaporization, and at a level which is higher than or equal to the vacuum level of the inner vacuum. Thereby, the waste bag is effectively prevented from collapsing inwards under influence of the inner vacuum. Without the outer vacuum, the waste bag may rupture when collapsing, and the reduced bag volume may result in waste material being sucked out of the waste bag. In order to prevent the waste bag from collapsing inwards in response to the inner vacuum, the outer vacuum should be at least equal to the inner vacuum. The inner vacuum should not be higher than the outer vacuum. To optimize the close contact between the waste bag and the inner sidewall of the container, the outer vacuum may be higher than the inner vacuum. In some embodiments, the level of the outer vacuum may vary from an initial level during bag installation to a different level during boiling, for instance to a level closer to the level of the inner vacuum.

In preferred embodiments of the inventive concept, the transferring of the aqueous waste material into the waste bag comprises an initial transferring of waste material into a new empty waste bag, and one or more subsequent transferring of waste material into the waste bag after vaporizing water from previously introduced waste material. As a non-limiting example, a first filling may be 25 liters. After an initial vaporization of e.g., 5 liters of water (and a remaining amount of 20 liters of water-reduced material), additionally 5 liters of waste material is transferred into the container. The re-filling procedure may be repeated, where the volume of subsequent fillings will decrease as the overall water-content of the waste material in the container reduces. In some embodiments where waste material is repeatedly transferred into the container, the inner vacuum may temporarily be dispensed with during the additional filling and re-applied during the subsequent boiling. However, the outer vacuum holding the waste bag into contact with the inner sidewall of the container may be maintained during the subsequent waste material fillings.

Using the inner vacuum is preferred for lowering the boiling point of the waste material. A lower boiling point has the advantage of providing a higher temperature difference between the heated inner sidewall of the container and the boiling waste material. As an example, the boiling point may be lowered by the inner vacuum to about 30 to 20 degrees Celsius. Lowering the boiling point is a specific advantage if a heat pump is used for heating the inner sidewall of the container. In preferred embodiments, condense heat from the vaporized water is used by a heat pump to heat the inner sidewall. The hot side of a heat pump may typically not exceed 70 degrees Celsius. By lowering the boiling point by the inner vacuum, the temperature difference may be held, as an example, at a level of 70−30=40 degrees Celsius.

The above and other optional features of the inventive concept are set out in the dependent claims.

### BRIEF DESCRIPTION OF THE DRAWINGS

The inventive concept, some non-limiting embodiments, and further advantages of the inventive concept will now be described with reference to the drawings in which:

FIG. 1 illustrate an embodiment of an apparatus according to the invention, connected to external components.

FIG. 2a is a cross-sectional view of a container of the apparatus in FIG. 1.

FIG. 2b is a top view of the container in FIG. 2a and a coupling sleeve.

FIG. 3 is an exploded view of the container in FIG. 2, and a waste bag.

FIG. 4 is a perspective view of a waste bag.

FIG. 5 is a perspective view of a cabinet.

FIG. 6 is a cross-sectional view of the cabinet in FIG. 5.

FIGS. 7a-7h illustrate a bag removal sequence.

### DETAILED DESCRIPTION OF PREFERRED EMBODIMENTS

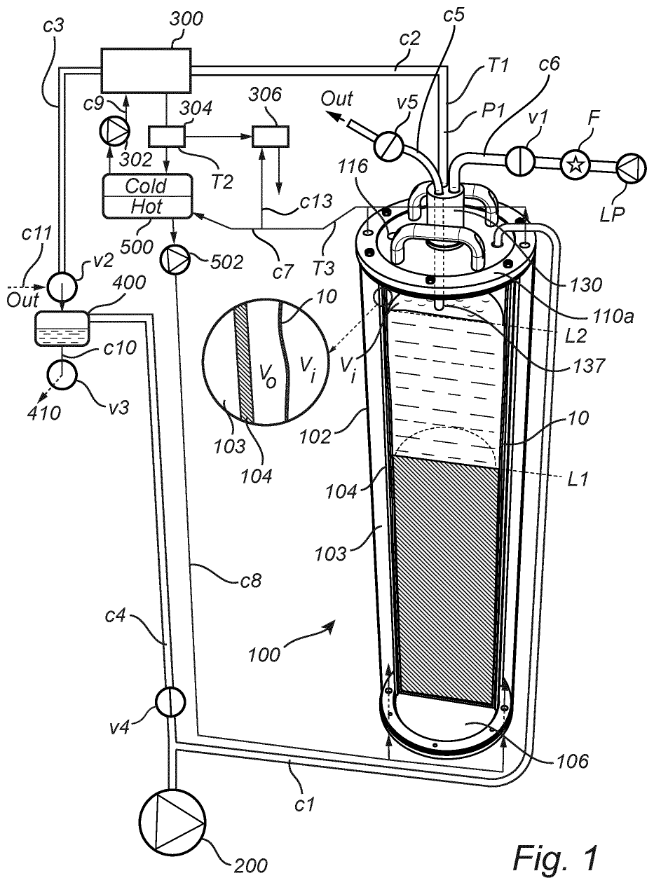

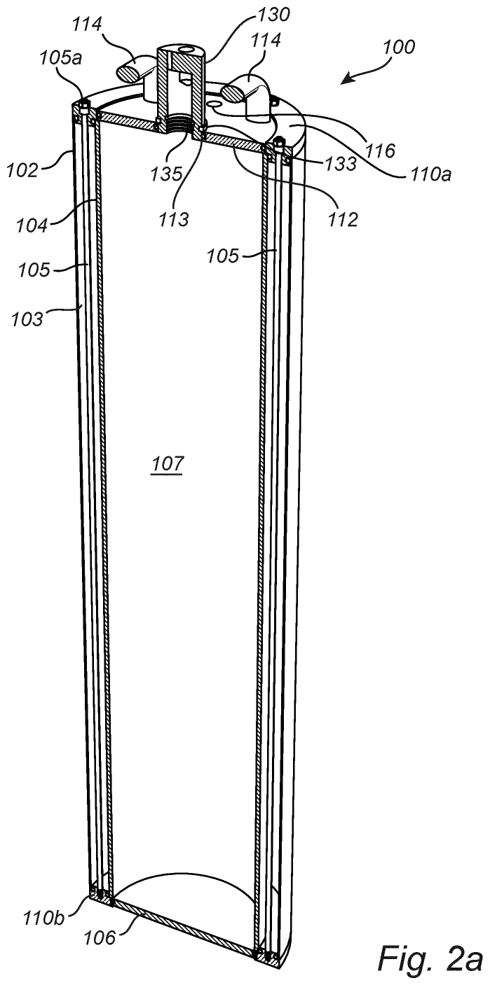

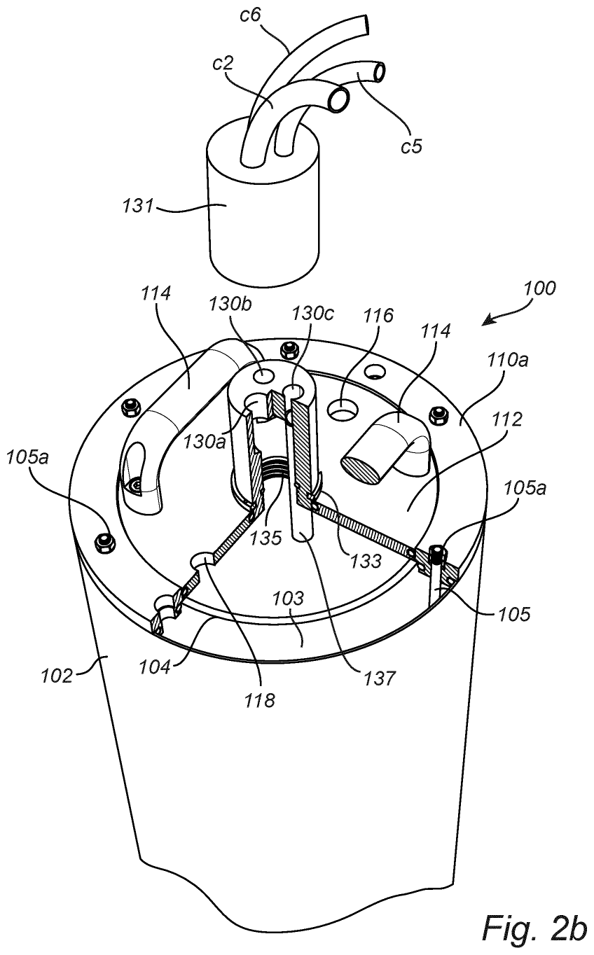

FIG. 1 schematically illustrates an embodiment of a waste handling apparatus according to the invention, connected to a number of external units. Reference is also made to FIGS. 2a, 2b, and 3 to 6 showing details of the embodiment of the apparatus.

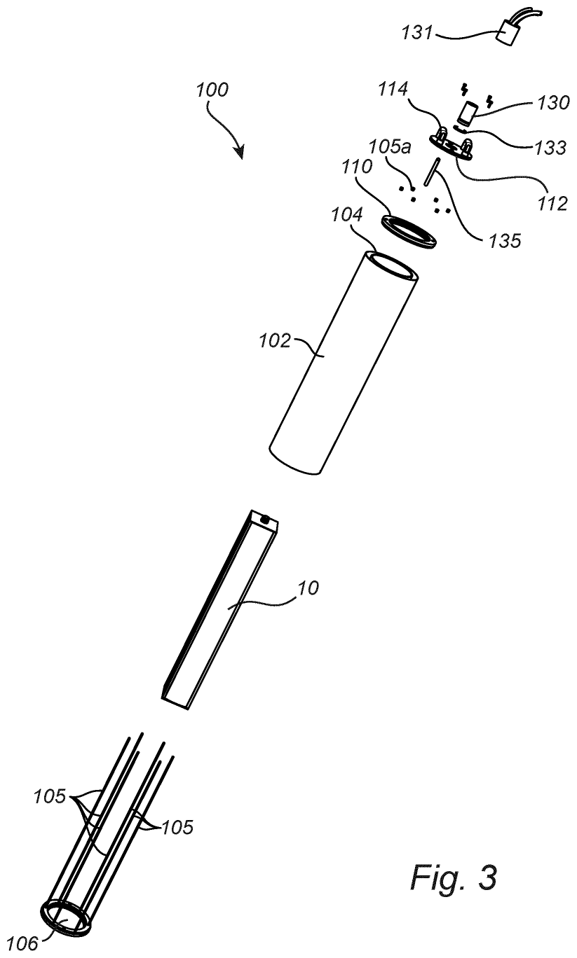

The apparatus comprises a container 100 having an inner chamber 107 arranged to receive a single-use waste bag 10. An embodiment of the container 100 is shown more in detail in FIGS. 2a, 2b and 3. The container 100 comprises a cylindrical outer wall 102 and an inner cylindrical wall 104. The outer wall 102 and the inner wall 104 are mounted between a top gable ring 110a and a bottom gable ring 110b to form a cylindrical space 103 for receiving a heating liquid, such as heated water. The two gable rings 110a and 110b are held together by a tension bars 105 secured by nuts 105a to the gable rings. A container bottom 106 is sealingly fitted into the bottom gable ring 110b. An openable top lid 112 is sealingly fitted into the top gable ring 110a. The inner wall 104, the bottom 106, and the lid 112 together define the bag-receiving inner chamber 107 of the container 100. The container 100 may typically be made at least in part from metal. The outer wall 102 may be manufactured from a thin sheet material, such as stainless steel. The inner wall 104 is preferably made from a material having a high thermal conductivity for efficient heat transfer from the heating liquid to the waste material inside the waste bag 10 received in the inner chamber 107. The inner wall 104 may be made from aluminum and may be thicker than the outer wall 102. As non-limiting examples for illustration, the inner bag-receiving chamber 107 of the container may be cylindrical with a diameter of 190 mm and a height of 1000 mm, giving an inner volume of about 28.3 liters.

A coupling unit 130 is arranged to be detachably connected to the waste bag 10 for transferring water vapor out from the waste bag 10, for transferring waste material into the waste bag 10, and for selectively establishing a connection between the outside air and inside of the waste bag 10. The coupling unit may be for single-use of for repeated use. The coupling unit 130 is also used for applying an inner vacuum Vi inside the waste bag 10 as will be discussed below. The mechanical connection is provided by a female thread 135 of the coupling unit 130 for receiving a male thread of a bag connector 12 defining a fill opening of the waste bag 10, For the above purposes of transferring gases and liquids, the coupling unit 130 comprises three passageways extending from the exterior into the interior of the attached waste bag 10. Referring to FIG. 2b, a first passageway 130a is arranged for leading water vapor out from the waste bag 110 during operation. The first passageway 130a is also used for applying an inner vacuum Vi inside the waste bag 10. A second passageway 130b of the coupling unit 130 is arranged for transferring aqueous waste material into the waste bag 10. A third passageway 130c allows to establish a communication between the inside of the waste bag 10 and the ambient air. Each one of the passageways 130a-c is provided with a self-closing valve mechanism (not shown) which closes the respective passageway during bag replacement. During operation, the coupling unit 130 is received in and is detachably and coupled to a matching coupling sleeve 131 for establishing a connection between the passageways 130a-c and the conduits c2, c6, and c5, respectively, in FIG. 1. The above-mentioned self-closing valve mechanisms are automatically opened in response to attaching the coupling sleeve 131 to the coupling unit 130.

In the illustrated embodiment, the lid 112 of the container 100 is completely detachable from the top gable ring 110a. Two handles 114 are provided for this purpose. The lid 112 is provided with as larger center opening 113 and two smaller openings 116 and 118. The coupling unit 130 is sealingly received in the larger center opening 113 and held in place by a detachable lock ring 133. The coupling unit 130 may be detached from the lid 112 during bag replacement as will be described below. The first smaller opening 116 is provided with a viewing glass for inspection of the inner chamber 107 of the container 100.

The second smaller opening 118 of the container lid 112 is connected to a vacuum pump 200 via a conduit c1 as shown in FIG. 1 for applying an outer vacuum Vo inside the inner chamber 107 of the container 100, but outside the waste bag 10. While the encircled part in FIG. 1 schematically illustrates the outer vacuum Vo between the waste bag 10 and the inner sidewall 104. It will be appreciated that during application of the outer vacuum Vo, the space shown in the encircled part in FIG. 1 between the waste bag 10 and the inner sidewall 104 will actually not be precent due to the outer vacuum VO.

In the illustrated embodiment, the vacuum pump 200 is also arranged to apply an inner vacuum Vi inside the waste bag 10. As an alternative, separate vacuum pumps may be used for the two vacuums. The inner vacuum Vi is applied to the inside of the waste bag 10 by the vacuum pump 200 via a path including a valve v4, a conduit c4, a condensate container 400, a valve v2, a conduit c3, a heat exchanger 300, and a conduit c2 in communication with the passageway 130a of the coupling unit 130. According to the inventive concept, during operation, the inner vacuum Vi is lower or equal to the outer vacuum Vo.

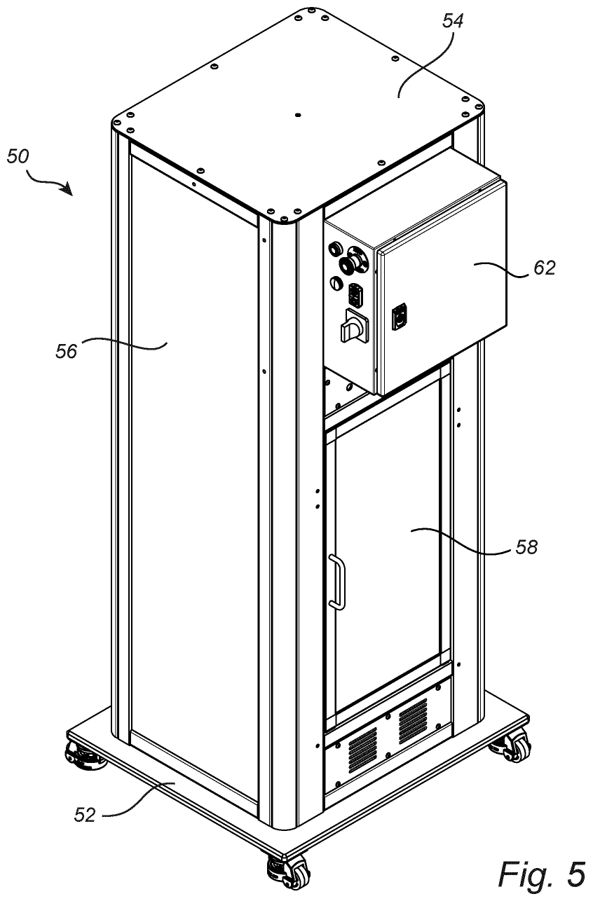

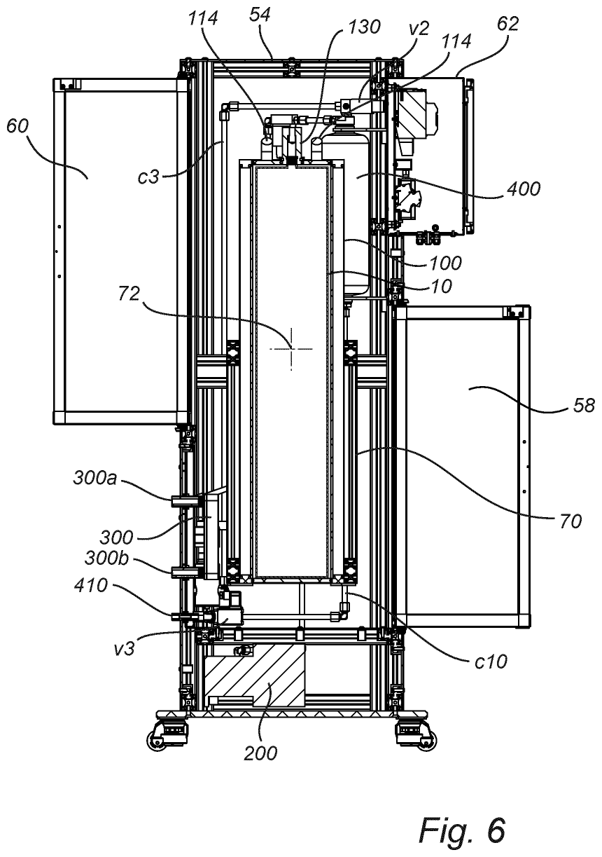

In some embodiments, the container 100 may be provided inside a cabinet 50 containing further components of the apparatus. FIGS. 5 and 6 illustrate an example of such a cabinet 50 on wheels. The invention may also be implemented without such a cabinet. The cabinet comprises bottom 52, here provided with wheels, a top 54, two opposite side walls 56, a front door 58, and a rear door 60. The front door 58 and the rear door 60 may be vertically displaced in relation to each other as shown. A control unit 62 containing control electronics is provided at the frontside of the cabinet 50. As shown in the sectional view in FIG. 6, the vacuum pump 200 is arranged at the bottom 52 of the cabinet 50. The heat exchanger 300 and the condensate container 400 are also contained in the cabinet 50. A cage 70 for carrying the container 100 is pivotably arranged inside the cabinet 50. The cage 70 is pivotable about a horizontal pivot axis 72. Using a supporting cage 70 has the advantage that the outer wall 102 of the container 100 can be made of a relatively thin-walled material. Using a cage 70 also has the advantage of making the container 100 pivotable without attaching any pivot means directly on the container 100.

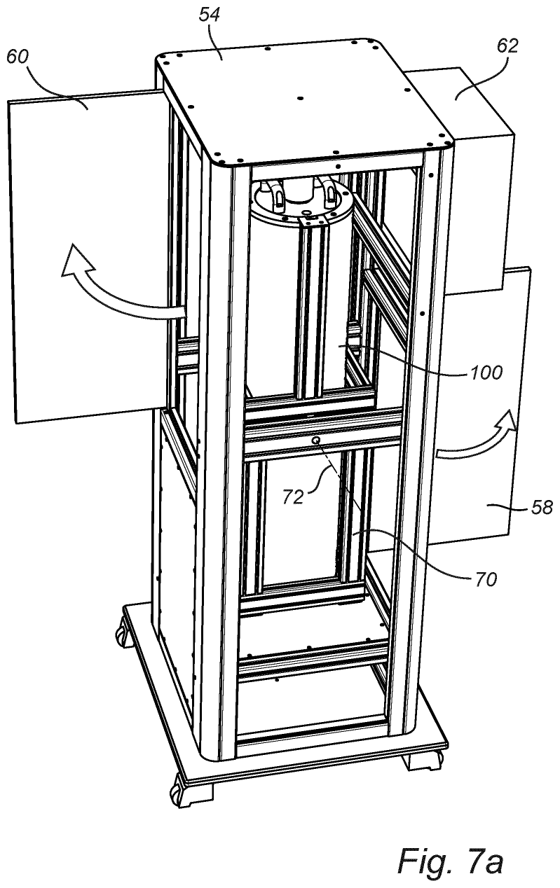

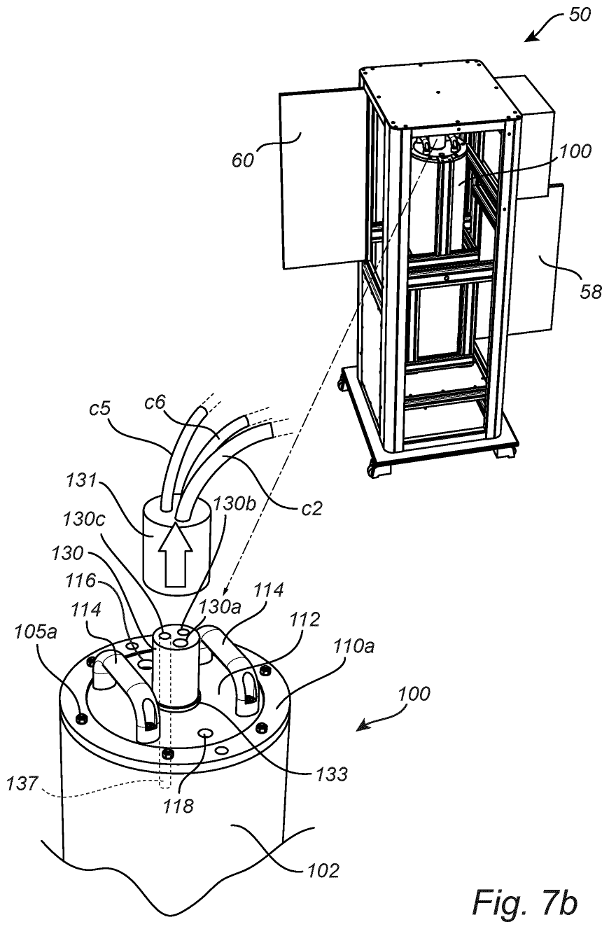

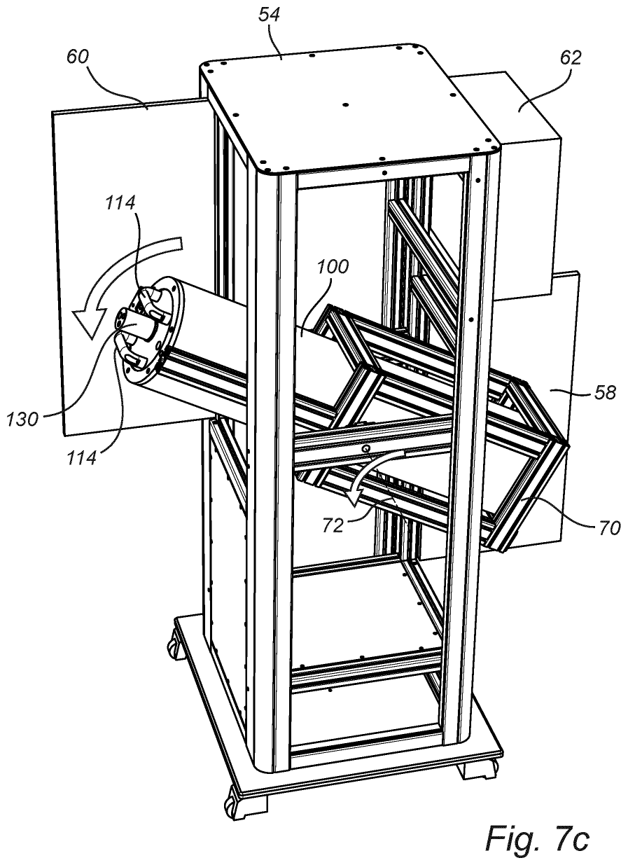

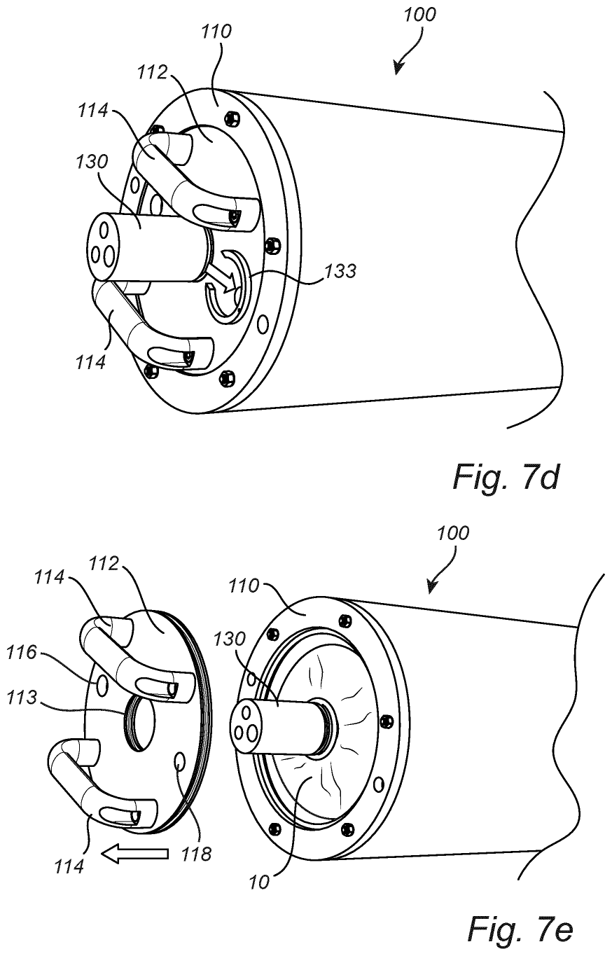

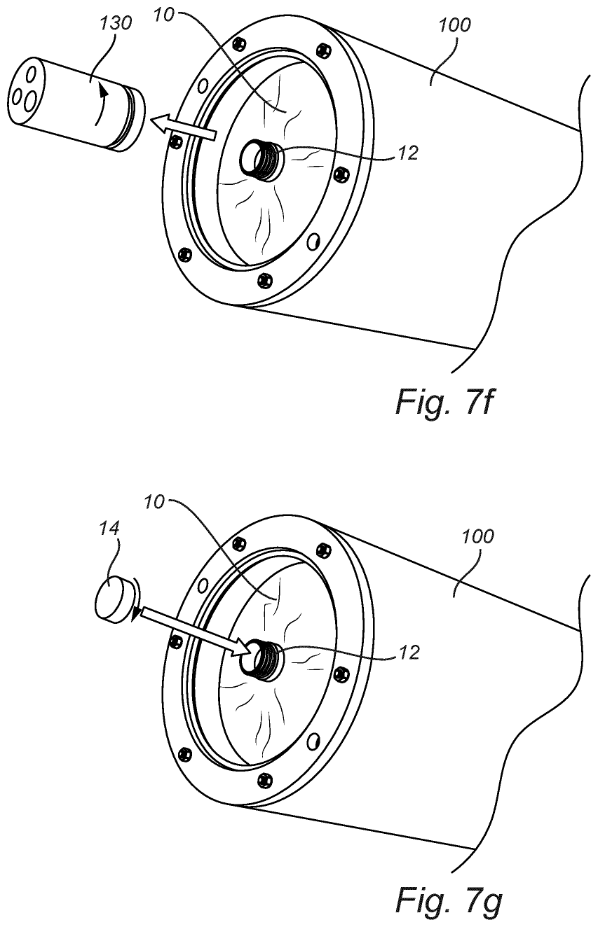

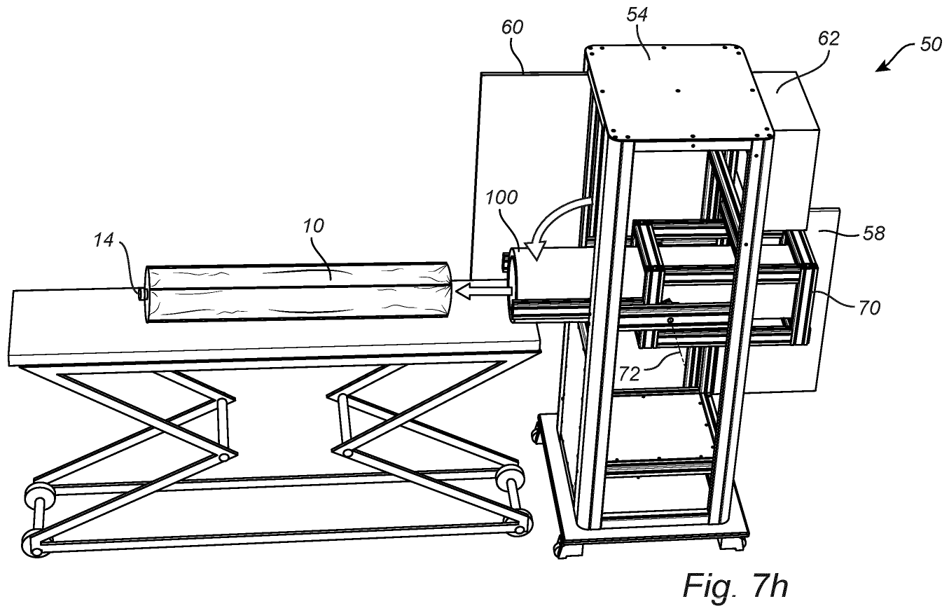

FIGS. 7a, 7c, and 7h illustrate how the cage 70 and the container 100 carried by the cage 70 can be pivoted from its normal essentially vertical position in FIG. 6 for bag replacement as will be discussed more in detail below. As will be appreciated, the two vertically shifted doors 58 and 60 allows the cage 70 and the container 100 to be swung out of the cabinet 50.

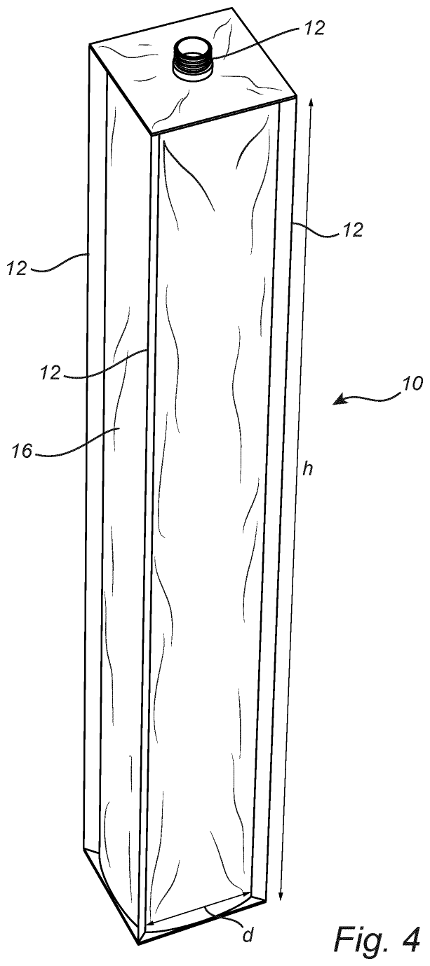

FIG. 4 schematically illustrates an example of a waste bag 10. In preferred embodiments, single-use waste bags 10 are used, wherein the waste bag 10 is typically destroyed together with the waste residual, e.g., by incineration. The waste bag 10 may typically be a relatively thin-walled bag. The thickness may be less than 6 mm. In preferred embodiments, the bag thickness is less than 0.5 mm, and especially less than 0.2 mm. A small bag thickness has the advantage of providing a more efficient heat transfer from the inner container wall 104 to the waste material. A small bag thickness has also the advantage of the waste bag 10 being more flexible to adapt to the shape of the inner chamber 107 of the container 100. The waste bag 100 may made from foil material. In preferred embodiments, the waste bag may be made at least partly from a metal foil, such as an alumina foil. A plastic foil may also be possible, and especially a combination of metal foil material and plastic foil material may be preferred. An advantage of using a metal foil is to increase the strength of the waste bag 10. A metal foil may also provide an increased heat transfer.

As an illustrative, non-limiting example, the waste bag 10 has a thickness of 0.16 mm, wherein a third or less of the thickness is made from alumina foil and the remainder is made from a plastic material, preferably surrounding the metal foil.

In preferred embodiments, the waste bag is “oversized” in relation to the inner chamber of the container in which it is received. Specifically, a maximum volume of the waste bag 10 is preferably sufficiently large in relation to the inner dimensions of the bag-receiving inner chamber 107 of the container 100 to prevent the waste bag 10 from expanding to its maximum volume. Such a design of the waste bag 10 in relation to the container chamber 107 prevents rupture of the waste bag 10 due to excessive bag expansion. As an illustrative, non-limiting example, the waste bag in FIG. 4 may have a height h of 1035 mm and an essentially initial square cross-section with a side length d of about 150 mm. During use, the shape of the waste bag 10, at least part thereof, will adapt to the interior of the container 100.

In order to accomplish an efficient heat transfer to the waste material inside the waste bag 10, the waste bag 10 may be shaped as an elongate tube as shown in FIG. 4 with a limited cross section, and be oriented essentially vertically oriented during use as shown in FIG. 6. Limiting the cross-sectional area of the waste bag 10 has the advantage of providing a more efficient heat transfer to the waste material therein. An elongate shape of a vertically standing waste bag is beneficial for performing a repeated filling of waste material into the waste bag.

### Operation

The operation of the apparatus and the overall setup in FIG. 1 for handling the waste material will now be described with reference to FIGS. 7a-7h. During operation, the control unit 62 receives temperature and pressure sensor signals as will be described, and generates control signals to control pumps, valves, heating means, etc. The operation will be automatic to a large extent.

For illustration purposes, the operation will be described starting from a state where the treatment of waste material in a waste bag 10 has been completed, and the full waste bag 10 is to be replaced by a new empty waste bag 10.

With all vacuums removed and heating deactivated, the cage 70 with the container 100 therein assumes the vertical position shown in FIG. 6. The front door 58 and the rear door 60 are opened as shown in FIG. 7a, allowing access to the interior or the cabinet 50. As shown in FIG. 7b, the coupling sleeve 131 is detached from the coupling unit 130. In response thereto, the valve mechanisms in the passageways 130a-c of the coupling unit 130 are all automatically closed.

With the coupling sleeve 131 detached, the cage 70 with the container 100 therein is swung out from the cabinet 50 as shown in FIG. 7c. In some embodiments where there coupling unit 130 is to be re-used, the cage 70 may initially be pivoted to a non-horizontal, angled position of for instance 30 degrees from vertical. In this angled intermediate position, the coupling unit 130 can be replaced with a screw cap without risk of treated waste material comes out of the waste bag 10.

As shown in FIG. 7d, the lock ring 133 is removed for releasing the coupling unit 130 from the lid 112. The lid 112 is then removed as shown in FIG. 7e. The provision of the handles 114 has the advantage that the removal of the lid is facilitated in case there is a tight fit between the lid 112 and an O-ring in the opening of the container. FIG. 7e illustrates how the shape of the filled waste bag 10 corresponds to the inner contour of the container 100. Next, the coupling unit 130 is unscrewed from the waste bag 10 as shown in FIG. 7f. and replaced by a single-use screw cap 14 as shown in FIG. 7g.

The cage 70 with the container 100 therein is now pivoted to the horizontal position shown in FIG. 7h. In this position, the full waste bag 10 is removed from the container 100. As an illustrative example, the full waste bag 10 is pulled out on a lift table or the like for transportation. Typically, the full waste bag 10 is subjected to incineration. In some embodiments of the inventive concept, the waste bag 10 is in itself not strong enough to carry the weight of the treated waste material.

In alternative embodiments, for instance when handling especially hazardous waste material, the removal of the coupling unit 130 in FIG. 7f and the replacement with a screw cap 14 in FIG. 7g may be dispensed with in order to avoid the temporary open state. Instead, the cage 70 may be pivoted directly to its horizontal position in FIG. 7h with the coupling unit 130 still in place. In this position, a user may pull the lid 112 by the handles 114 to draw the full waste bag 10 out from the container 100. The coupling unit 130 is thereafter detached from the lid 112 by removal of the lock ring 133. Thereafter, the full waste bag 10 with the coupling unit 130 still attached is transported for further handling.

When the previously filled waste bag 10 with the treated waste material therein has been removed from the container 100, a new empty waste bag 10 is to be attached and inserted by performing the operation described above in reverse order. The coupling unit 130 is threaded onto the threaded bag connector 12 of the new empty waste bag 10. Thereafter, the coupling unit 130 is inserted through the center opening 113 of the lid 112 and secured in a sealed position by the lock ring 133. Thereafter, the new waste bag 10 is inserted into the inner chamber 107 of the container 100. If the new waste bag 10 is delivered in an initially folded state, it may optionally be at least partly unfolded before insertion into the chamber 107. Thereafter, the lid 112 is reattached to the top gable ring 110a of the container 100. In some embodiments, the lid 112 is held in place by the outer vacuum Vo only. The container 100 with the new waste bag 10 therein is now brought into the vertical position in FIG. 6 by pivoting the cage 70 about the pivot axis 72. In the vertical position, the sleeve coupling 131 in the cabinet 50 is re-attached to the coupling unit 130 thereby connecting the inside of the new waste bag 10 to the conduits c2, c5, and c6. In response thereto, the self-sealing valve mechanisms in the passageways 130a-c of the coupling unit 130 are automatically opened.

Next, the vacuum pump 200 is activated, and an outer vacuum Vo is applied outside the waste bag 10 in the inner chamber 107 via conduit c1 from the vacuum pump 200. During this initial application of the outer vacuum Vo, the valve v4 is closed so that the vacuum generated by the vacuum pump 200 is applied only outside the waste bag 10. During the initial application of the outer vacuum Vo, a valve v5 in the conduit c5 is open in order to allow air from the outside to enter into the waste bag 10 when the latter expands in response to the outer vacuum Vo. In response to the application of the outer vacuum Vo, the new empty waste bag 10 can be unfolded completely and is forced/pressed by the outer vacuum Vo against the inside of the inner wall 104 of the container 100. The shape of the waste bag 10, over a substantial part of the waste bag, will thereby change from the shape shown in FIG. 4 to an essentially cylindrical shape corresponding to the inner shape of the bag-receiving chamber 107 of the container 100. As mentioned above, the waste bag 10 is preferably oversized in relation to the dimension of the inner chamber 107 in such a way that the outer vacuum Vo will not rupture of the waste bag 10. In preferred embodiments, there is now a close contact between the entire sidewall of the waste bag 10 and the inner wall 104 of the container 100. Also, the waste bag 10 is preferably resting on the bottom 106 of the container 100.

An amount of aqueous waste material, e.g., contaminated water, is now transferred into the waste bag 10 held against the inner wall 104 of the container 100. The waste material may contain harmful or dangerous substances. In some applications, such substances may be at least party dissolved in water.

The waste material is fed into the waste bag 10 by a low-pressure fill pump LP via a flow sensor F, a valve v1, a conduit c6, and the passageway 130b in the coupling unit 130. The flow sensor F measures the flow volume and sends a sensor signal to the control unit 62. The vacuum valve v4 is still closed. The air valve v5 is open to the outside, allowing air to escape from the waste bag 10 during filling. A valve v2 at the condensate chamber 400 is closed to ensure that air from the waste bag 10 exits through conduit c5, whereby the pressure P1 in the waste bag 10 can be measured during filling. During filling, P1 will be at an essentially constant level. When the rising liquid level L2 in the waste bag 10 reaches a level pipe 137, which is connected to conduit c5 and extends downwards from the coupling unit 130 into the waste bag 10, a sudden raise in pressure P1 will be detected by the control unit 62. In response thereto, the valve v1 is closed and the fill pump LP is deactivated. As an illustrative example, the initial fill volume of waste material may be around 25 liters. In order to obtain an efficient boiling, the waste bag 10 is preferably filled to a relatively high degree. In alternative embodiments, the fill pump LP may be dispensed with if the waste material is present at a higher level to obtain a flow without a pump.

In alternative embodiments, the initial filling of waste material into a new waste bag 10 may be performed entirely or in part before the application of the outer vacuum Vo.

The waste material in the waste bag 10 inside the container 100 is now ready to be subjected to an evaporation process for vaporizing water from the waste material by boiling. To accomplish the vaporization, the inner wall 104 of the container 100 is heated. In the present embodiment, the heating energy is at least partly obtained from condensation heat in the heat exchanger 300 receiving via the conduit c2 water vapor from the waste bag 10. Condensate is transferred from the heat exchanger 300 to the condensate container 400 via the conduit c3, and condensation heat is transferred from the heat exchanger 300 by a pump 302 to the cold side of a heat pump 500. The fluid present in the two chambers of the heat pump 500 must be allowed to change volume due to temperature variations. For this purpose, a minor expansion tank 306 may be provided. At start-up, heat is taken from the cold side of the heat exchanger 300. If the temperature T2 is too low, extra heat energy may be added to the fluid by a water heater 304. When T2 reaches a threshold, the water heater 304 is deactivated. The hot side of the water heater 304 and the hot side of the heat pump 500 may have a common expansion chamber 306. The heating medium may be water. Heat energy is transferred from the hot side of the heat pump 500 by a circulation pump 502 and a conduit c8 to the inner space 103 of the container 100 for heating the inner wall 104. The water is recirculated back to the heat pump 500 via a conduit c7. Reference numerals 300a and 300b in FIG. 6 indicate where the conduits c7 and c8 are attached to the cabinet 50. The temperature T3 of heated water is measured, either at the exit at 110a or at the entry at 110b. T1 and T3 are both indicators of a proper evaporation process.

During the evaporation process, it is preferred that the boiling occurs at a lowered temperature. As previously mentioned, a lower boiling point has the advantage of providing a higher temperature difference between the heated inner sidewall 104 of the container 100 and the boiling waste material. As an illustrative non-limiting example, the boiling point may be lowered to about 30 to 20 degrees Celsius. Lowering the boiling point is especially advantageous when—as in the present embodiment-a heat pump 500 is used for heating the inner sidewall 104 of the container 100. The temperature T3 of the hot side of the heat pump 500 may typically not exceed 70 degrees Celsius. By applying the inner vacuum Vi to lower the boiling point, the temperature difference T3-T1 may be held, as an example, at a level of 70−30=40 degrees Celsius. For obtaining an efficient heat transfer process and boiling process, this temperature difference should preferably be kept as large as possible. To lower the boiling point, the inner vacuum Vi is applied in the interior of the waste bag 10 during boiling. The inner vacuum Vi is applied by opening the vacuum valve v4 and by setting the 3-way valve v2 in a position where the conduits c4 and c3 are connected to each other. A drain valve v3 at an outlet conduit c10 from the condensate chamber 400 is closed during boiling and the application of the inner vacuum Vi. The outer vacuum Vo is maintained during the boiling process to maintain the waste bag 10 in contact with the inner wall 103 of the container 100, thereby preventing the flexible waste bag 10 from being drawn by the inner vacuum Vi into the interior of the container chamber 107. According to the inventive concept, the inner vacuum Vi is therefore lower or equal to the outer vacuum Vo.

In the shown embodiment it will be appreciated that in response to opening the valves v2 and v4 for application of the inner vacuum Vi, the outer vacuum Vo and the inner vacuum Vi may tend to level out. However, due to the boiling inside the waste bag 10 the inner vacuum Vi will normally and automatically be lower than the outer vacuum Vo holding the waste bag 10 in place. As a non-limiting example, the inner vacuum Vi inside the waste bag 10 may be in the range of 0.1-0.5 atm.

In alternative embodiments, with a different valve control and/or with separate vacuum pumps for the inner and outer vacuum, the outer vacuum Vo can be held constantly at a selective higher level than the inner vacuum Vi.

It may also be noted that if the vacuum pump 200 is deactivated, it may itself act as a valve to maintain applied vacuum. Thus, in some embodiments the vacuum pump 200 does not have to run all the time during the vaporization process.

In preferred embodiments, the waste bag 10 is preferably repeatedly re-filled. The refilling is preferably performed such that that the waste material in the waste bag 10 is maintained at a rather high level L2. After a first boiling phase, a certain amount of water has vaporized and been removed from the waste bag 10 via conduit c2 to the condensate container 400. As an example, 20% of the initial liquid volume (e.g., 25 liters) has vaporized. Refilling can take place at various time intervals, for instance every 15 minutes, every hour, etc. As an example, around 8 to 10 liters of water may be vaporized per hour. For refilling the waste bag 10 with essentially the same amount of additional waste material (e.g., 5 liters), the application of the inner vacuum Vi is temporarily deactivated by closing the vacuum valve v4. During refilling, the valves v1 and v5, and the pump LP at conduits c5 and c6 are set as described above for the initial filling. After refilling, the inner vacuum Vi is applied again, and the boiling continues. The tube 137 is used as described above for deactivating the fill pump LP at the desired level L2.

As the refilling and subsequent boiling is repeated, the remaining material in the waste bag will present a gradually lower overall water content. If the waste material transferred to the waste bag 10 comprises substances dissolved in water, the repeated refilling and boiling process will eventually lead to a saturated state where an essential solid waste residual builds up at the bottom of the waste bag 10 as schematically indicated at level L1 in FIG. 1. The re-fill volume of waste material will therefore gradually decrease. The flow meter F measures the material flow during refilling. The control unit 62 detects when the re-fill amount reaches a certain lower limit, indicating time for bag replacement as described above. It may also be noted that as the amount of solid residual waste material builds up in the waste bag 10, the surface available for heat transfer for vaporization will decrease, leading to a lower re-fill volume.

At suitable time intervals, which may be independently of the fill process described above, a drain process is initiated to drain the condensate container 400. This process may be automatically controlled and initiated by the control unit 62. The 3-way valve v2 is changed to a position where the valve v2 connects the condensate container 400 to the ambient air “Out”, and where the valve v2 closes against conduit c3. In this position, the valve v2 blocks the vacuum pump 400 for applying the inner vacuum via conduit c3. However, the valve v2 keeps the conduit c3 closed during draining, whereby the inner vacuum Vi in the waste bag 10 will be maintained essentially unchanged so that boiling at a lowered boiling point may continue also during the draining. The draining of condensate water is performed via conduit c10 and valve v3. During the draining process, also the vacuum valve v4 should be closed to maintain the outer vacuum Vo.

In some embodiments, there may be provided an additional valve (not shown), for instance located in conduit c1 near the vacuum pump 200, for releasing both the outer vacuum Vo and the inner vacuum Vi before bag replacement.

The filling and vaporization operation continue as described above until the waste bag 10 is full of finally treated waste material. Thereafter, the full waste bag 10 is removed and replaced as described above.

### ALTERNATIVE EMBODIMENTS

The embodiments described above and as shown in the figures may be varied in many ways without departing from scope of the claims.

In the illustrated embodiment, some of the components in the setup in FIG. 1 are not included in the cabinet 50 and may be considered as external parts of the inventive apparatus. In other embodiments, such external components may be considered part of the apparatus and may be included in a cabinet 50. Such external component include for example the heat exchanger 300, the heat pump 400, the circulation pumps 302 and 502, the water heater 304, and corresponding conduits.

In alternative embodiments, the use of condensation heat may be dispensed with. The heating of the waste material may be performed by alternative means. The container does not have to be a double-walled container. In simpler embodiments, the container may be a single-walled container. Furthermore, the container may be heated by different means, such as a heat spiral, a heat bag, etc. In simpler embodiments, the cabinet 50 and the cage 70 may be dispensed with.

In alternative embodiments, the transferring of liquids/gases to and from the waste bag may be implemented in a different way. For example, the separate coupling unit may be dispensed with and replaced by connectors formed directly in the lid or other parts of the container.

1. An apparatus for handling aqueous waste material, comprising:
a waste bag;
a container arranged to receive the waste bag;
means for applying an outer vacuum in the container outside the waste bag to hold the waste bag against an inner sidewall of the container;
means for transferring an aqueous waste material into the waste bag in the container;
means for applying an inner vacuum inside the waste bag to lower the boiling point of the waste material, wherein the inner vacuum is lower than or equal to the outer vacuum; and
heating means for heating the inner sidewall to accomplish a heat transfer through the waste bag into the waste material and, thereby, a vaporization of water from the waste material to produce a water-reduced waste residual in the waste bag.

2. The apparatus according to claim 1, wherein the waste bag, at least part thereof, has a thickness under 6 mm.

3. The apparatus according to claim 1, wherein the waste bag, at least part thereof, has a thickness under 0.5 mm, preferably under 0.2 mm.

4. The apparatus according to claim 1, wherein the waste bag is made at least in part from foil material.

5. The apparatus according to claim 4, wherein the foil material comprises metal foil material, such as alumina foil.

6. The apparatus according to claim 1, wherein the container is a double-walled container having an inner bag-receiving chamber defined by the inner sidewall, a container bottom, and a container top, and further having an outer sidewall; and wherein the heating means are arranged to heat the inner sidewall by applying heat in a space between the outer sidewall and the inner sidewall of the container.

7. The apparatus according to claim 1, wherein the waste bag is sufficiently large in relation to inner dimensions of the container that the waste bag is prevented from expanding, under the influence of the outer vacuum, to a maximum volume of the waste bag.

8. The apparatus according to claim 1, wherein the container comprises:
an openable container lid for allowing the waste bag to be received in the container, and
a bag coupling unit which is arranged to be connected to an opening of the waste bag and which is releasably and sealingly mounted in an opening in the openable top lid.

9. A method for handling aqueous waste material, comprising:
inserting a waste bag into a container;
applying an outer vacuum in the container outside the waste bag to hold the waste bag against an inner sidewall of the container;
transferring an aqueous waste material into the waste bag;
applying an inner vacuum inside the waste bag to lower the boiling point of the waste material, wherein the inner vacuum is lower than or equal to the outer vacuum;
while applying the inner vacuum, vaporizing water from the waste material in the waste bag to produce a water-reduced waste residual in the waste bag, wherein said vaporizing being accomplished by heating the inner sidewall of the container and by heat transfer from the heated inner sidewall, through the waste bag, and to the waste material in the waste bag; and
removing the waste bag with the waste residual therein from the container.

10. The method according to claim 9, wherein the outer vacuum is applied at least after inserting a new waste bag into the container, before initiating the transfer of waste material into the new waste bag.

11. The method according to claim 9, wherein the outer vacuum outside the waste bag is applied while applying the inner vacuum inside the waste bag during vaporization.

12. The method according to claim 11, wherein the outer vacuum is maintained higher than the inner vacuum.

13. The method according to claim 9, wherein the act of transferring the aqueous waste material into the waste bag comprises an initial transferring of waste material into a new empty waste bag, and one or more subsequent transferring of waste material into the waste bag after vaporizing water from previously introduced waste material.

14. The method according to claim 9, further comprising, before or after inserting a new waste bag into the container:
connecting an opening of the new waste bag to a bag coupling unit to establish a connection allowing transferring of the waste material into the waste bag, allowing application of the inner vacuum inside the waste bag, an allowing removal of vaporized water from the waste bag.

15. The method according to claim 9, further comprising condensation of at least some of the vaporized water, and transferring condensation heat from said condensation to the container for heating the latter.
